(19) United States
(12) Patent Application Publication
(10) Pub. No.: US 2016/0168805 A1
(43) Pub. Date: Jun. 16, 2016

(54) Artificial Sliding Mat

(71) Applicant: Mr. Snow GmbH, Chemnitz (DE)

(72) Inventors: Arndt Schumann, Chemnitz (DE); Jens Reindl, Chemnitz (DE); Felix Neubert, Chemnitz (DE)

(21) Appl. No.: 15/051,923

(22) Filed: Feb. 24, 2016

Related U.S. Application Data
(63) Continuation-in-part of application No. PCT/EP2014/067968, filed on Aug. 25, 2014.

(30) Foreign Application Priority Data
Aug. 24, 2013 (DE) 102013014285.7

(51) Int. Cl. E01C 13/12; D03D 15/10; B62B 15/00

(52) U.S. Cl. CPC E01C 13/12; B62B 15/00; D03D 15/10; D10B 2507/00

(57) ABSTRACT

The invention relates to the field of artificial sliding mats or textile pistes of plastic, which are provided for sliding thereon in sliding fashion with sports devices suitable for this purpose. The artificial sliding mat is formed substantially of at least one sliding surface segment having a woven fabric. The woven fabric comprises a combination of warp threads and weft threads and has floating warp threads and non-floating warp threads in one fabric direction.

### CROSS-REFERENCE TO RELATED APPLICATIONS

This application is a continuation-in-part application of International Patent Application No. PCT/EP2014/067968 filed on Aug. 25, 2014, which claims priority to and benefit of the filing of German Patent Application DE 10 2013 014 285.7 filed on Aug. 24, 2013.

The aforementioned applications are hereby incorporated by reference in their entirety.

### BACKGROUND OF THE INVENTION

1. Field of the Invention

The invention relates to the field of artificial sliding mats made, for example, of plastic. These artificial sliding mats are mainly used to carry out winter sports independently of the weather, particularly when there is a lack of snow.

A further application of the artificial sliding mats of the invention is the use as a sliding surface for conveyor belts.

2. Brief Description of the Related Art

Artificial sliding mats for use with winter sports equipment have been known for several decades. There are various systems with surfaces having snow-like properties. These snow-like properties include, for example, the support of the sports equipment, the sliding behavior, the shock absorption and risk of injury hazard due to the nature of the surface. The artificial sliding mats are installed on a base, for example on the flat for travelling thereupon with cross-country skis or on slopes for use with alpine skis, snowboards, ski jump skis as well as toboggans and snow tubes. The base on which the artificial sliding mat is installed can be formed from natural soil, from concrete, etc., or from a scaffold structure.

The artificial sliding mats of the prior art comprise, for example, injection-molded plastic grid-like mats. On the approx. 2 cm wide bars of the grid, plastic pins of the same height are arranged, which provide the function of artificial snow. For use in ski jumps and snow tubes, mats made of cross-pieces with attached plastic rods are known.

Large surface area mats of tufted or woven pile fabric are also known from UK Patent Application No. GB 2 394 902. The pile thread of this patent application consists of synthetic monofil yarns or foil yarns.

In the French patent application No. FR 2 772 053 an artificial sliding surface formed of a grid-shaped knitted fabric is described. Monofilament yarns are used.

In the German patent application No. DE 2318415 A a cross-country skiing track for use with the classic technique is described. The tracks are placed individually on the ground. Each track has plastic panels used as sliding surface. The panels are provided with scales to increase the friction between the ski and the plastic panels when pushing off with the leg. The track is defined by laterally applied square-cut sections opened out upwardly at an angle. In the sections grooves are introduced for form-fixing the plastic panels.

In the German patent application No. DE 10 2005 062 711 A1 a sliding surface formed of nipples is described. The sliding surface is coated with fluoropolymers. In a wet test and with the use of lubricants a coefficient of friction of less than μ=0.06 is achieved relative to the ski.

The German patent application DE 288982 A5 relates to artificial ski running tracks especially for ski jumps. Described therein are special modules having air outlet openings, in order to create a friction-reducing air cushion between the ski and the base.

A base made of plastic with nipples made of ceramic material arranged thereon in a grid shape is described in German Utility Model No. DE 20211137 U1. In the further development described in the International Patent Application No. WO 2008151748 A1, the protrusions can be replaced. The material and shape of the nipples is varied.

The German Utility Model No. DE 1871540 U describes a cross-country ski track for training using the classic technique. The track is made of a plastic section and has grooves on the sliding surface in the direction of motion.

In all systems, the irrigation of the sliding surface or the treatment of the sliding surfaces with lubricants has a friction-reducing effect. However, the irrigation must be carried out permanently, as these prior art systems have no water storage function.

The known artificial sliding mats are not sufficiently adapted to practical requirements, which can be summed up in the following points:
The frictional resistance is very high in all systems.
The guiding property of the sports equipment is insufficient.
Due to construction and material used, there is a high to very high risk of injury is present in most systems.
The installation of the systems is sometimes complicated.
In the majority of the systems permanent irrigation of the artificial sliding mats is necessary to obtain an acceptable sliding effect. The systems have no water storage function.

### SUMMARY OF THE INVENTION

An artificial sliding mat is described which is cost-effective to produce and easy to install.

The artificial sliding mat is composed substantially of a textile that forms the sliding surface, an intermediate layer and an underlying back coating. The artificial sliding mat can also be termed a textile piste due to the predominantly textile construction.

The textile is a woven fabric comprising warp threads and weft threads and having floating and non-floating warp threads in one fabric direction. The warp threads can form a surface and are produced from a material or a mixture of materials selected from the group consisting of: PE, PP, PBT, PET or PA.

Further, lubricants can be added to the textile to reduce friction and thus increase the sliding effect.

The woven fabric can be constructed of spliced yarn, monofilament yarn, monofilament ply yarn, a meshwork of monofils or monofil. The woven fabric of the segment can comprise further a back coating. The back coating of the segment can be formed by at least one of: PVC, styrol butadiene, PUR, latex, PES, PE, PP or hot-melt adhesive.

The artificial sliding mat can be made from at least two segments. In this case, the segments can be connected together via connecting elements or joined together to form a belt in the form of a circumferential band. The connecting elements can comprise Velcro fasteners or zippers.

It is possible to limit the textile piste by outer wall elements. The textile piste can have cross-pieces. In one aspect, an outer skin of the outer wall elements and/or of the cross-pieces can be formed of the woven fabric or from a core of foamed material.

Further, in the textile piste, the outer wall elements and/or cross-pieces can be filled with plastic and/or biological material.

Further, in the textile piste, the outer skin of the outer wall elements can be formed of foil or fleece.

Further, in the textile piste, the cross-pieces of a pliable material or plastic section can be attached on the textile piste.

The invention can also be used for conveyment purposes. On the one hand, for example, goods can be transported in a sliding or gliding fashion over the segments, and on the other hand for example conveyor belts can be equipped with the invention, such that when a jam of the goods to be transported occurs on the belt, the same can slide underneath the goods without a large frictional resistance.

### BRIEF DESCRIPTION OF THE DRAWINGS

For a more complete understanding of the present invention and the advantages thereof, reference is now made to the following description and the accompanying drawings, in which:

FIGS. 1A-1D show the triple-layer structure of the textile piste. Representation in the views: FIG. 1A is a plan view, FIG. 1C is a lateral view from the right, FIG. 1D is a lateral view from the left and FIG. 1B is a bottom view

FIG. 2 shows a cross section through the triple-layer textile piste. The cross section is radial to the extension of the warp threads. The figure illustrates the structure of various warp threads.

FIG. 3 shows the cross section through the textile piste with various attachment variants.

FIGS. 4A-4D show the textile piste with various connection variants.

FIGS. 5A-5F show a textile piste with perimeter walls and profile sections of the perimeter walls.

FIGS. 6A-6D show the cross section through a perimeter wall which is created by plying the textile piste.

FIGS. 7A-7C show a textile piste with track guide.

FIGS. 8A-8D show a textile piste with further variants of track guiding.

FIG. 9 shows a textile piste with support profile for forming a track guide.

FIG. 10 shows diverse embodiments of track profiles.

FIG. 11 shows a track profile of reshaped panel material.

### DETAILED DESCRIPTION

In the following, a detailed description of the invention will be given, which is described further below with examples. First, general features are given with reference to the drawings.

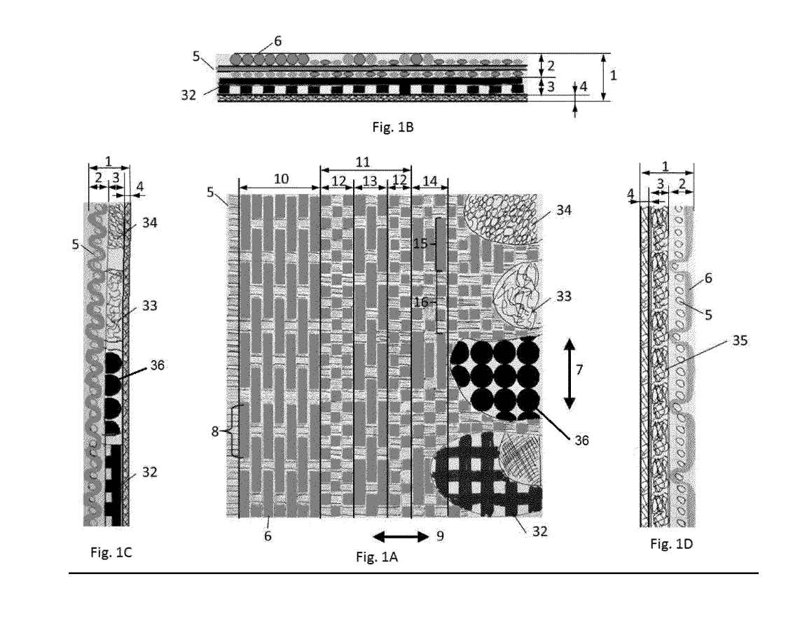

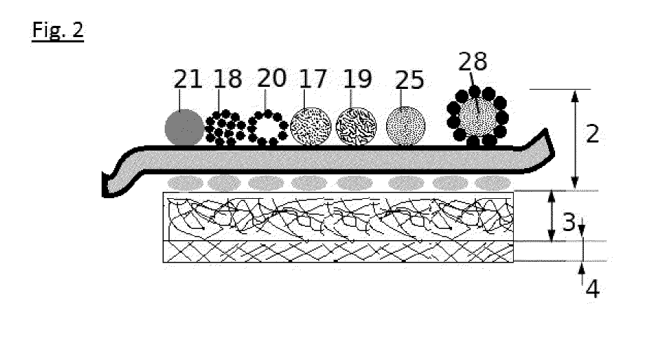

A textile piste is substantially formed of segments of the artificial sliding mat, which has a sliding surface (FIGS. 1A-1D; 1 and FIG. 2). The artificial sliding mat has a fabric (FIGS. 1A-1D, FIG. 2; 2) forming the sliding surface, an intermediate layer (FIGS. 1A-1D, FIG. 2; 3) and an underlying back coating (FIGS. 1A-1D, FIG. 2; 4). The artificial sliding mat is also referred to as textile piste hereinafter, due to the predominantly textile construction, and its use as an artificial piste or ski run. The term “textile piste” should not be taken to mean that the artificial sliding mat can only be used for ski runs, as will be explained below.

The fabric is a woven fabric having a plain weave or twill weave in a simple embodiment.

The fabric is preferably aligned such that the direction of travel (FIGS. 1A-1D; 7) and the orientation of the warp threads (FIGS. 1A-1D; 6) coincide. Especially in this arrangement the following constructions are used because of favorable properties similar to a snow piste.

The sliding surface (FIGS. 1A-1D; 2) of the fabric or segment is formed of warp threads (FIGS. 1A-1D; 6, 8) having float stitches over five weft threads (FIGS. 1A-1D; 5), such that the distance of the float stitch amounts to 1.3 to 1.6 cm. In a further embodiment, the sliding surface of the fabric is formed of warp threads floating over 2 to 20 weft threads, such that the thickness amounts to 3 mm to 10 cm. The warp threads (FIGS. 1A-1D; 6) are disposed tightly next to each other in the weft direction (FIGS. 1A-1D; 9), such that an almost closed surface (FIGS. 1A-1D; 10) is created and the warp threads form a large wear volume.

In a further embodiment, the warp threads are arranged in the weft direction at a defined spacing (FIGS. 1A-1D; 11), which is formed by respectively one or many non-float warp threads. Whereby elevated areas extending in the weaving direction alternate with lowered areas, thereby alternately forming ridges (FIGS. 1A-1D; 13) and grooves (FIGS. 1A-1D; 12). The elevated areas formed of float warp threads have a width of 0.5 cm to 5 cm. The lowered areas without float warp threads are 0.2 cm to 5 cm wide. The webs and grooves act to stabilize the sports equipment sliding thereon and support its guiding in the direction of travel. In ski jumping, this fabric surface has a particularly positive effect upon landing and descending.

In one aspect based on this fabric surface (FIGS. 1A-1D: 14) the float stitches (FIGS. 1A-1D; 15) in the weaving direction are interrupted by non-float stitching areas (FIGS. 1A-1D; 16). The areas without the float stitching (FIGS. 1A-1D; 16) have a length of 3 cm to 10 cm and alternate with areas of the float stitching (FIGS. 1A-1D; 15) having a length of 3 cm to 12 cm. Through this surface configuration, the fabric is suitable for installations in the landing area and off-run area of ski jumps, since the fabric enables a safe and decelerating snowplow descent.

The warp threads (FIGS. 1A-1D; 6) that have the float stitches and serve as the sliding surface are formed of a material with particularly pronounced sliding properties, preferably of PET or FBT. In further embodiments of PE, PP, or PA, and of mixtures of these substances or with plastic with added lubricants, carbon black, graphite, molybdenum disulfide and silicone. The preferred textile constructions of the warp threads are spliced yarns (FIG. 2; 17) and monofilament yarns or monofilament ply yarn (FIG. 2; 18). In further embodiments, the warp threads are formed from ribbon yarn (FIG. 2; 19), from monofil meshwork (FIG. 2; 20), or individually disposed monofils (FIG. 2; 21). The thickness of these warp threads amounts to at least 1 mm and not more than 4 mm.

Alternatively, the float warp threads in the weft direction are formed of different materials and/or differ through the textile structure of the warp thread. Thus, smooth warp threads (FIG. 2; 22), which bear 60% to 90% of the burden of the sports equipment, are arranged next to lubricant-storing and/or water-storing warp threads (FIG. 2; 23), which wet the sliding surface of the sports equipment with lubricant or water. The smooth, supporting warp threads are preferably formed of spliced yarns (FIG. 2; 17) or monofilament yarns (FIG. 2; 18). In a further embodiment, the warp threads are formed of ribbon yarn (FIG. 2; 19), of monofil meshwork (FIG. 2; 20) or individually disposed monofils (FIG. 2; 21). The preferred material is PET or PBT. Alternatively, the yarn is formed of PE, PP or PA or a mixture of these, or plastic with added lubricants, carbon black, graphite, molybdenum disulfide and silicone. The warp threads disposed next thereto (FIG. 2; 23) with water or lubricant storage function are preferably made of multifilament yarn (FIG. 2; 25) and alternatively of open-cell foam (FIG. 2; 26), fleece strips (FIG. 2; 27) or multifilament meshwork.

Alternatively, the float warp threads are formed of a core-jacket construction (FIG. 2; 24). Wherein the core consists of a lubricant-storing or water-storing construction of multifilament yarn (FIG. 2; 28), staple fiber yarn and in further embodiments of fleece (FIG. 2; 29), open-cell foam (FIG. 2; 30) multifilament meshwork or spliced yarn. The jacket is preferably formed of monofils (FIG. 2; 31) enveloping the core in helical shape or of monofils enveloping the core as a meshwork.

The sliding surface is preferably produced by weaving, but can also be produced using the tufting method.

Below the fabric there is arranged a 2 mm to 30 mm thick second layer (FIGS. 1A-1D; 3) with a water storage and/or shock absorbing and/or wear and/or stiffening function.

The second layer (FIGS. 1A-1D; 3) is connected to the textile layer disposed there above by adhesive bonding, riveting, welding, sewing or needling.

The second layer (FIGS. 1A-1D; 3) can comprise a plastic mesh.

The second layer (FIGS. 1A-1D; 3) alternatively comprises a three-dimensional random fiber arrangement (FIGS. 1A-1D; 33) made of plastic.

The second layer (FIGS. 1A-1D; 3) can further comprise a plastic mesh with fleece arranged intermediately or above or below.

The second layer can further comprise an open- or closed-cell foamed material (FIGS. 1A-1D; 34).

The second layer alternatively comprises a fleece (FIGS. 1A-1D; 35).

The second layer further comprises alternatively a bubble wrap (FIGS. 1A-1D; 36).

On the lower side of the sliding surface there can be applied to the second layer, or if the second layer is omitted, there can be applied to the upper layer, a back coating that is fixating, stabilizing and/or protecting against wear and/or providing for good adhesion to the ground (FIG. 1; 4). This back costing can be formed of styrol butadiene, PVC, PUR, latex or a hot-melt adhesive.

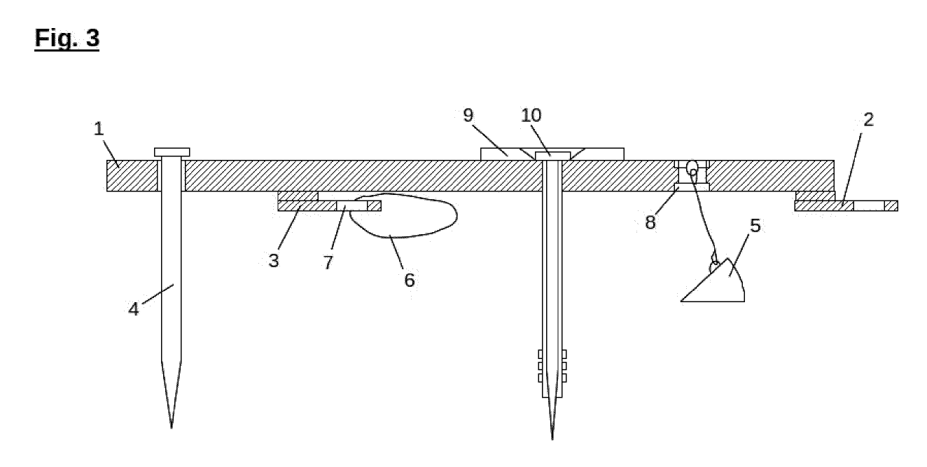

The artificial sliding mat (FIG. 3; 1) can be provided with tabs for attachment at the edge (FIG. 3; 2) or in covered fashion on the lower side (FIG. 3; 3). The connection of the tabs to the ground is effected by e.g. pegs (FIG. 3; 4), ground anchors (FIG. 3; 5), cable ties (FIG. 3; 6) or similar connectors. The connectors are pushed through loops formed on the tab or holes disposed in the tab (FIG. 3; 7.). The holes can be reinforced by eyelets (FIG. 3; 8). When plate anchors are used in combination with pegs or ground anchors (FIG. 3; 9, 10) the attachment can be effected directly through holes in the textile piste, since the pegs are hidden in the anchor and for this reason do not pose a risk of injury. It is also expedient for the attachment of the piste to cut holes of a diameter of 2 to 10 cm (FIG. 3; 11) into the mat, to close the opening from below with a strip of fabric or textile piste and to connect said strip from the other side by sewing, adhesive bonding or welding (FIG. 3; 12). A hole of a diameter of 0.5 to 2 cm (FIG. 3; 13) is punched into said strip and can be reinforced by an eyelet. Through the hole, a connector, such as e.g. a peg or ground anchor is struck or screwed into the ground. In this arrangement, the connector does not project beyond the sliding cover, thereby preventing injuries. The connector can be covered with a strip of the piste cover in addition (FIG. 3; 14).

For connecting several ones of the artificial sliding surfaces or for the lateral connection thereof (FIG. 4A; 2), elastic loop band or Velcro strip (FIGS. 4A and 4B; 3), snaps (FIG. 4C; 6) or a zipper (FIG. 4D; 7), are applied to the tabs or the tab (FIG. 4A; 5) or directly to the sliding surface.

The textile piste can be provided with patterns, crests, logos, images and lettering and signal and track imaging markers by embroidery, sewing, embossing, printing or weaving.

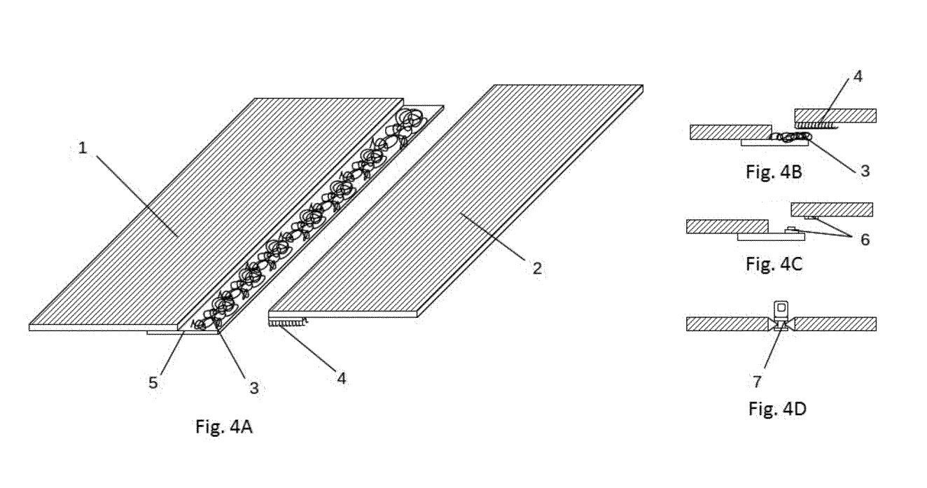

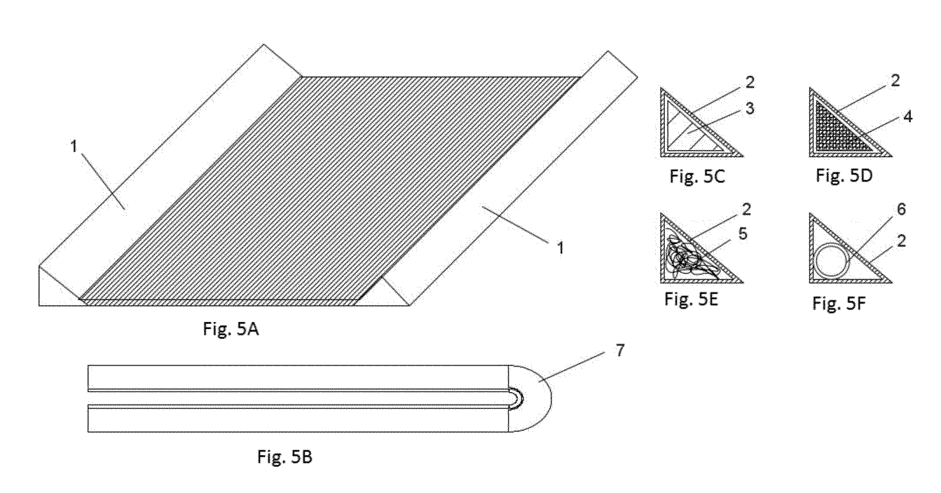

To guide sliding sports equipment, such as e.g. toboggans or snow tubes, and for limiting ski and toboggan runs, these are provided with perimeter walls at the edge (FIG. 5A; 1). The perimeter wall is made of a closed surface, such as PVC as sheath (FIGS. 5A-5F; 2) and a lightweight and flexible or rigid shaping core as a filler material, e.g. foamed material (FIG. 5C; 3) or plastic (FIG. 5D; 4) or straw (FIG. 5E; 5) or plastic tube (FIG. 5F; 6) or sand, formed such that it can be folded/plied (FIG. 5B; 7) or is also rigid.

In addition, tabs can be applied for attachment at the edge of the outer wall or in concealed fashion at the lower side. The connection of the tabs to the ground is effected for example with pegs, ground anchors, cable ties or similar connectors. The connectors are pushed through loops formed on the tab (FIG. 3; 2) or holes disposed in the tab (FIG. 3; 7). The holes (FIG. 3; 7) can be reinforced by eyelets. For connection with the downhill run above, below or adjoining laterally, in addition elastic loop band or Velcro strip (FIG. 4B; 3), snaps (FIG. 4C; 6) or a zipper (FIG. 4D; 7) are provided on the tabs (FIG. 4A; 5) or the tab.

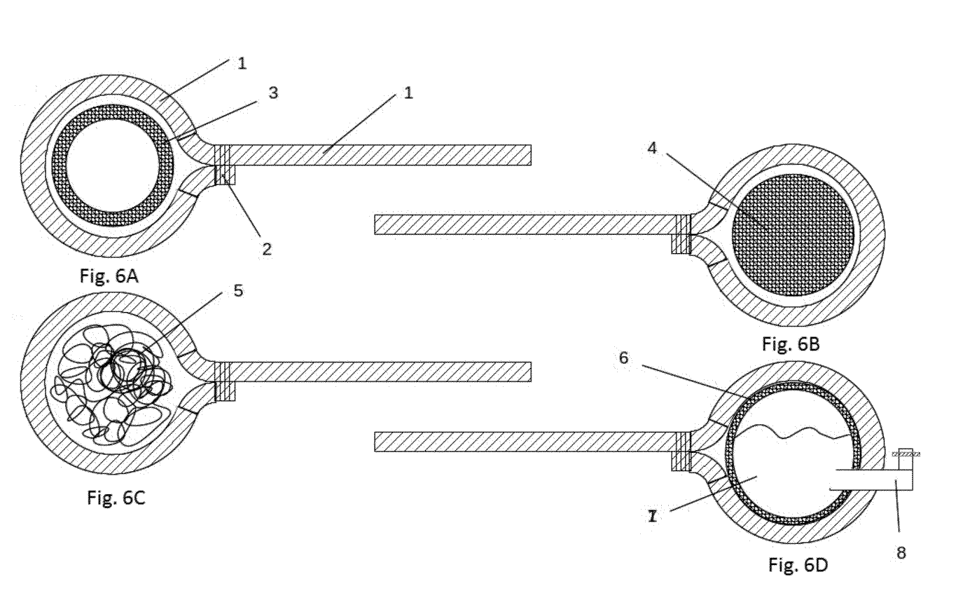

Alternatively, the outer wall can also be produced directly from the piste material (FIGS. 6A-6D; 1), by folding the same over and sewing, adhesively bonding or welding together while forming a hose-like cavity (FIGS. 6A-6D; 2). The cavity is filled with foamed material (FIG. 6B; 4), plastic, straw (FIG. 6C; 5), flexible tubing, rigid pipe (FIG. 6A; 3) or a bulk material of plastic or biomass. In a further embodiment, a hose is introduced into the cavity (FIG. 6D; 6) which can be filled with filling material such as air, water (FIG. 6D; 7), sand, etc. and emptied again via a discharge valve (FIG. 6D; 8).

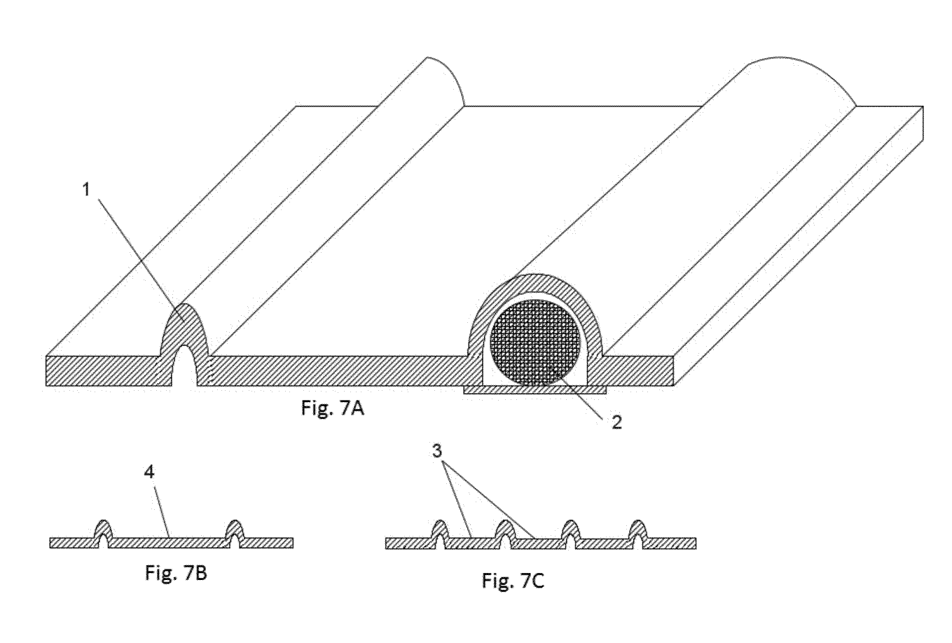

It is expedient to form a profiled, modular track guide for sliding sports equipment by folding the piste material on itself (FIGS. 7A-7C; 1) or by enclosing a filling material by additional structures (FIG. 7A; 2). The guide can be configured in such a way that it can guide cross-country skis, alpine skis or ski jump individually (FIG. 7C; 3), thus one ski in each case, or jointly (FIG. 7B; 4). In a further embodiment, the track can also be produced for more than one pair of skis or for one or several snowboards. Further, the track can be used for guiding tobogganing devices.

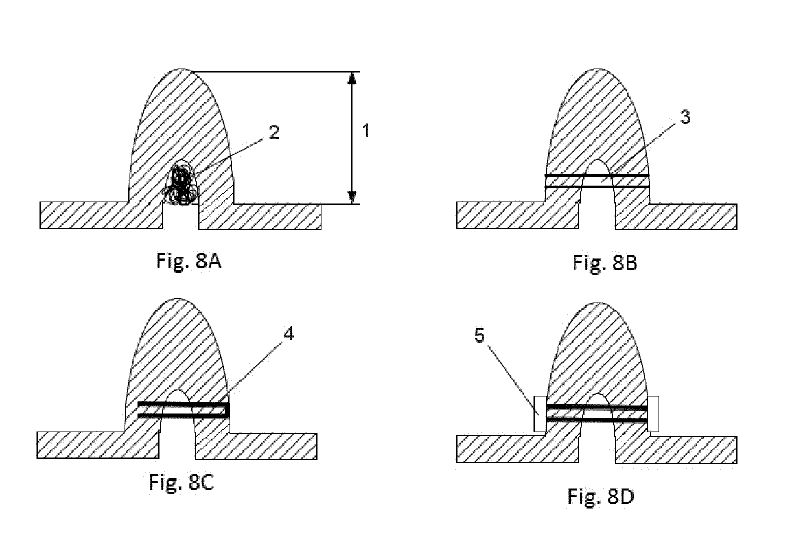

The track guide is formed by fixing one or several folds of the piste material on itself or the track profile of filling material has a height of 0.5 cm to 4 cm (FIG. 8A; 1). The fixation of the fold/folds or the enclosing of the filling material is effected by adhesive bonding (FIG. 8A; 2), welding (FIG. 8A; 2), sewing (FIG. 8B; 3), stapling (FIG. 8C; 4) or riveting (FIG. 8D; 5).

In a further embodiment, the fold/the folds is/are held in shape by a support profile of plastic, metal, foamed material or wood. The fixation is effected, as already mentioned above, by adhesive bonding, welding, sewing, stapling or riveting. Moreover, a mounted profile of an enclosing, moldable material is expedient, such as fabric-reinforced PVC foil or PE foil, in combination with a filling material in a molded loop. It is also possible to use solely the material without filling. In a further embodiment, the mounted profile can be produced of plastic, plastic recycling materials, wood or plastic foam. All variants of fixing the mounted profile mentioned herein can be effected by adhesive bonding, welding, sewing, nailing, stapling or riveting.

In an alternative, the track-forming folds can be interrupted at regular and irregular intervals. The interruptions of the track-guiding folds are applied mainly in the lift entrance area and lift exit area, as well as in intermediate entrance and exit areas, or serve for safety, e.g. for turning the sports device sideways.

The front-side fixation of the modules is effected by a tab with eyelets applied thereto. Wherein connectors such as e.g. ground anchors, pegs (FIG. 3; 4) and cable binders are struck into the ground through the eyelets. In a first embodiment, the tab is attached along the front side to the lower side of the textile piste by adhesive bonding, sewing, riveting or welding and is flush with the front side. To the lower side of the mat and the upper side of the tab there is applied elastic loop band or Velcro strip in order to fix the textile piste in the area of the tab.

In an alternative embodiment, the tab is attached along the front side to the lower side of the textile piste by adhesive bonding, sewing, riveting or welding and projects with the eyelets beyond the front side. After the attachment of the piste, the visible part of the tab can be covered by a piece of sliding cover. The sliding cover is preferably connected releasably to the tab by a Velcro connection or connected inseparably by adhesive.

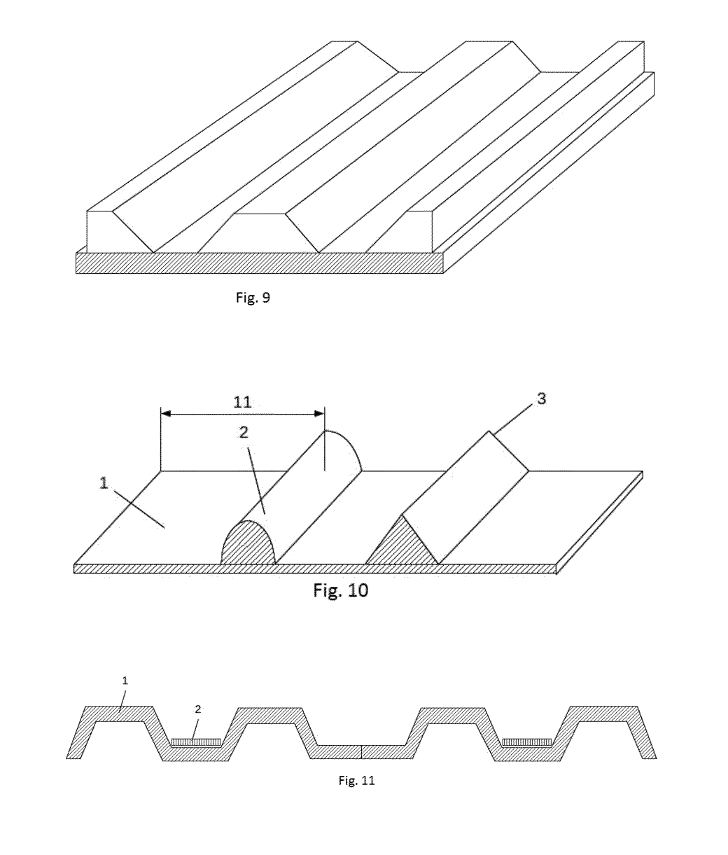

A track guiding for ski jump skis, cross-country skis, alpine skis and snowboards, as well as toboggans can also be achieved by covering a track profile of wood, plastic, metal, flexible foam, rigid foam or Purenit. A base plate (FIG. 10; 1) can be comprised therein. On the base plate rail-shaped profiles are mounted for guidance on the left and on the right. The rails have a semicircular (FIG. 10; 2), rectangular, square or triangular profile (FIG. 10; 3) and are connected to the base plate by screwing, adhesive bonding, riveting or stapling. The base plate is flush with the structures on the left and on the right side. When the outer structures are configured to be 10 cm to 50 cm wide (FIG. 9), they can be used simultaneously as a contact surface for the pole tips when used for cross-country skiing. In an alternative, the base plate projects beyond the edge structures by 10 cm to 50 cm (FIG. 10; 11). Again, the base plate can be used simultaneously as a contact surface for the pole tips when used for cross-country skiing. The track guide can also be formed in the textile piste (FIG. 11; 2) of a single piece, for example from a reshaped track-shaped plate (FIG. 11; 1) of sheet steel or plastic. Also execution from a single piece of solid material of wood, plastic, rigid foam, flexible foam is expedient.

The textile sliding cover or at least a sliding surface segment is applied at least at the bottom of the track or spans the complete surface or only a part thereof. The rail profiles can be used simultaneously for attachment of the sliding cover, by laterally clamping the same. The contact surface for pole tips can additionally be covered with a particularly hard wearing material. The possibility of exchanging the worn material and of the textile sliding cover is enabled by connecting by adhesive bonding, screwing, clamping or Velcro connection.

### EXAMPLE 1

The example relates to the textile piste used as a toboggan and snow tubing run (FIG. 5A; 1).

The textile piste is constructed of two layers. The upper layer, on which the snow tubing or the tobogganing device slides, is formed by the sliding surface (FIG. 1 and FIG. 2; 2) and is produced of a woven fabric. The lower layer (FIGS. 1A-1D and FIG. 2; 4) is a back coating.

The sliding surface of the fabric is formed by warp threads passing over five weft threads (FIGS. 1A-1D and FIG. 2; 6), such that the float thread distance amounts to 1.3 to 1.6 cm. The float warp threads are disposed tightly next to each other in the weft direction (FIGS. 1A-1D; 9), such that an almost closed surface (FIGS. 1A-1D; 10) is created and the warp threads form a large wear volume. The fabric is oriented in the textile piste such that the longitudinal orientation of the warp threads coincides with the direction of travel (FIGS. 1A-1D; 7).

The float warp threads serving as the sliding surface are formed of the material polyester, which has particularly pronounced sliding properties. The textile construction of the warp threads is a monofilament yarn or ply yarn (FIG. 2; 18). The thickness of these warp threads amounts to 2 mm.

The weft threads (FIGS. 1A-1D and FIG. 2; 5) are formed of 2.5 mm thick polyester multifilament yarn.

For the fixation and stabilization of the upper layer and as a wear- and adhesion layer to the ground, a 2.1 mm thick back coating (FIGS. 1A-1D and FIG. 2; 4) of PVC is used.

Twenty pieces of the modules of the textile piste of a width of two meters and a length of ten meters are mutually adjoined consecutively to form a tobogganing and snow tubing run of a length of 200 meters.

To the left and the right side of the textile piste, outer walls are arranged for guiding the toboggans or snow tubes (FIGS. 6A-6D; 1). For this purpose the edges of the textile piste are folded, such that on the right and on the left a hose-shaped cavity is formed (FIGS. 6A-6D). These folds are fixed by sewing (FIG. 6A; 3). The cavity is filled up with flexible plastic tubing of a diameter of 125 mm (FIG. 6A; 3). Thereby the perimeter walls are provided with a circular profile shape.

At the upper edge of the modules a tab of a length of 5 cm is arranged respectively over the complete width. In this tab, five holes are arranged which are reinforced by eyelets. The outer holes are arranged at an offset of 10 cm from the right edge. The other holes are distributed over the tab at a spacing of 45 cm. On the lower side, disposed 10 cm from the right and the left edge, there are five tabs with eyelets in each case (FIG. 3; 3 and 7). The tabs are spaced apart by 2 m in the direction of travel. The fixation to the ground is effected by pegs (FIG. 3; 4) or screws.

The modules are arranged with an overlap of 20 cm in the direction of travel, such that the tabs, eyelets and pegs or screws at the upper edge are covered by the piste arranged there above.

The modules weigh around 50 kg and can be rolled up similarly to a carpet. Thereby the run can be transported particularly easily. The installation and removal can be realized quickly and easily due to the fixation with pegs.

### EXAMPLE 2

The example 2 describes the textile piste used as a ski jump mat. The textile piste is installed on the landing slope of ski jumps for this purpose.

The sliding surface (FIGS. 1A-1D; 2) is formed by a fabric of the float warp threads and the non-float warp threads (FIGS. 1A-1D; 12 and 13). The fabric is provided with a coating on the lower side (FIGS. 1A-1D and FIG. 2; 4).

The textile piste is installed such that the longitudinal orientation of the warp threads coincides with the direction of travel (FIGS. 1A-1D; 7).

The loss of the warp threads (FIGS. 1A-1D; 6) is effected over five weft threads (FIGS. 1A-1D; 5) and amounts to 1.3 cm to 1.6 cm. In the weft direction, areas with the float warp threads (FIGS. 1A-1D; 13) alternate with the non-float warp threads (FIGS. 1A-1D; 12) at a ratio of 1:1. Thereby, ridges and grooves are created, which stabilize the skis upon landing and descending. The ridges have a width dimensioning of around 2 cm and are formed of five mutually adjacent, floating warp threads. The grooves of a width of around 2 cm result from eight non-floating warp threads.

The float warp threads are formed of particularly smooth polyester monofilament ply yarn (FIG. 2; 18) of a yarn thickness of 2.5 mm. The non-floating warp threads are formed of polypropylene spliced yarn (FIG. 2; 17) of a yarn thickness of 2.5 mm to 3 mm.

The weft threads (FIGS. 1A-1D and FIG. 2; 5) are formed of 2.5 mm thick polyester multifilament yarn (FIG. 2; 25).

The fabric is coated on the lower side (FIGS. 1A-1D and FIG. 2; 4) with a 1 mm thick PVC layer.

The ski jump mats of a width of 2 m and a length of 5 m are mutually adjoined in order to cover large slopes. For this purpose, the mats are butt-joined laterally and connected by Velcro strip on the lower side (FIGS. 4A and 4B). In the direction of travel that coincides with the longitudinal orientation of the mats, the mats are arranged with an overlap of 20 cm.

At the upper edge of the modules five holes reinforced with eyelets are arranged over the complete width. The outer holes are arranged at an offset of 10 cm from the right edge. The other holes are distributed over the tab at a spacing of 45 cm. At the upper edge of the mats, a tab of a length of 5 cm is arranged along the complete width. In this tab, five holes are disposed which are reinforced by eyelets. The outer holes are arranged at an offset of 10 cm from the right edge. The other holes are distributed over the tab at a spacing of 45 cm. On the lower side, disposed 10 cm from the right and the left edge, there are five tabs with eyelets in each case (FIG. 3; 3). The tabs are spaced apart by 2 m in the direction of travel. The fixation to the ground is effected by pegs (FIG. 3; 4) or screws.

The tabs disposed at the upper edge of the mats are covered through the overlap of the mats in the direction of travel.

### EXAMPLE 3

Example 3 relates to the textile ski piste for use as the sliding surface for the off-run of ski jumps or also drag lift tracks.

The sliding surface (FIGS. 1A-1D; 2) is formed by a fabric of floating (FIGS. 1A-1D; 15) and non-floating warp threads (FIGS. 1A-1D; 16 and 12). The fabric is provided with a coating on the lower side (FIGS. 1A-1D and FIG. 2; 4).

The textile piste is installed such that the longitudinal orientation of the warp threads coincides with the direction of travel (FIGS. 1A-1D; 7).

The loss of the warp threads (FIGS. 1A-1D; 6) is effected over five weft threads (FIGS. 1A-1D; 5) and amounts to 1.3 cm to 1.6 cm. In the weft direction (FIGS. 1A-1D; 9), areas with the float warp threads (FIGS. 1A-1D; 14) alternate with the non-float warp threads (FIGS. 1A-1D; 12) at a ratio of 1:1. The float threads (FIGS. 1A-1D; 15) are also interrupted by the non-float areas (FIGS. 1A-1D; 16) in the direction of travel at a ratio of 1:1.

Thereby, ridges and grooves are created both in the direction of travel and transversal to the direction of travel. The ridges and grooves in the direction of travel stabilize the traveling, while the ridges and grooves transversal to the direction of travel increase the decelerating effect upon snowplow descent.

The ridges have a width and length dimensioning of around 2 cm. The grooves have a width of around 2 cm.

The warp threads (FIGS. 1A-1D; 6) are formed of polypropylene spliced yarn or monofilament (FIG. 2; 12; 17) of a yarn thickness of 0.5 mm to 33 mm.

The weft threads (FIGS. 1A-1D and FIG. 2; 5) are formed of 2.5 mm thick polyester multifilament yarn (FIG. 2; 25).

The fabric is coated on the lower side with a 0.5 mm thick PVC layer (FIGS. 1A-1D; 4).

The covering of the off-run area of a drag lift route is effected by adjoining the mats of a width of 2 m and a length of 10 m. The mats are butt-joined laterally and connected by Velcro strip on the lower side (FIGS. 4A and 4B). In the direction of travel that coincides with the longitudinal orientation of the mats, the mats are arranged with an overlap of 20 cm.

The mats are fixed at the left and right edge in the direction of travel at a spacing of 1 m by pegs or screws (FIG. 3; 4). The position of the pegs from the fabric edge amounts to 5 cm. At the upper edge of the mats, a tab of a length of 5 cm is arranged respectively of the complete width. In this tab, five holes are disposed which are reinforced by eyelets. The outer holes are arranged at an offset of 10 cm from the right edge. The other holes are distributed over the tab at a spacing of 45 cm. On the lower side, disposed 10 cm from the right and the left edge, there are five tabs with eyelets in each case (FIG. 3; 3). The tabs are spaced apart by 2 m in the direction of travel. The fixation to the ground is effected by pegs (FIG. 3; 4).

The tabs disposed at the upper edge of the mats are covered through the overlap of the mats in the direction of travel.

### EXAMPLE 4

Example 4 relates to a textile piste used as mat for cross-country skiing.

The mat is constructed of two layers. The sliding surface (FIGS. 1A-1D; 2) is formed by a fabric of floating warp threads (FIGS. 1A-1D; 6 and 10). A protective layer of fleece is arranged thereunder (FIGS. 1A-1D; 34).

The sliding surface of the fabric (FIGS. 1A-1D; 2) is formed of warp threads placed over five weft threads (FIGS. 1A-1D; 5), such that the loss amounts to 1.3 to 1.6 cm. The float warp threads (FIGS. 1A-1D; 9) are disposed tightly next to each other in the weft direction (FIGS. 1A-1D; 9), such that an almost closed surface is created and the warp threads form a large wear volume. The fabric is so oriented in the textile piste that the longitudinal orientation of the warp threads coincides with the direction of travel (FIGS. 1A-1D; 7).

The float warp threads serving as the artificial sliding surface are formed of the material polypropylene ester that has particularly pronounced sliding properties. The textile construction of the warp threads is a monofilament yarn or spliced yarn (FIG. 2; 187). The thickness of these warp threads amounts to 2 mm.

The weft threads (FIG. 2; 5) are formed of 2.5 mm thick polypropylene spliced yarn (FIG. 2; 17).

To carry out the classic cross-country skiing technique, a double track is incorporated in the artificial sliding surface. Each track guides one ski. The spacing between the tracks, when viewed from the center of the track, amounts to 23 cm. The track width is 6 cm to 7 cm. The configuration of the track and the guiding of the skis is effected by protrusions formed e.g. by folding the piste material. The bars or folds are 2.5 cm high and are fixed e.g. by sewing (FIG. 8B; 3).

The overall width of the mat amounts to 50 cm. The tracks are arranged such that the same spacing to the edge is formed on the left and on the right.

The artificial sliding mat can be modified by tracks is sewed up with the fleece layer arranged thereunder. The fleece is 6 mm thick and formed of meshed polypropylene fibers.

A cross-country skiing piste of a length of 400 m is assembled of 20 modules or mats of a length of 20 m by adjoining the front sides. The fixation to the ground is effected on the right and on the left and in the center of the front sides at a spacing of 5 cm from the edge by pegs (FIG. 3; 10) and plate anchors (FIG. 3; 9). The right and left side of the mat is anchored on the ground at a spacing of 5 cm from the edge every 2 m with a peg (FIG. 3; 10) and plate anchor (FIG. 3; 9).

From the above description, it is clear to the person skilled in the art that the individual, mutually independent features of the examples can be combined with each other as desired and/or can occur in several examples.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. An artificial sliding mat comprising a woven fabric, wherein the woven fabric comprises warp threads and weft threads, wherein the warp threads comprise a combination of float warp threads and non-float warp threads in one fabric direction.

2. The artificial sliding mat according to claim 1, wherein the warp threads form an upper sliding surface.

3. The artificial sliding mat according to claim 1, wherein the warp threads are produced of a material or a mixture of materials from the group: PE, PP, PBT, PET or PA.

4. The artificial sliding mat according to claim 3, wherein lubricants are added to the material or the material mixture.

5. The artificial sliding mat according to claim 1, wherein the woven fabric is constructed from spliced yarn, monofilament yarn, monofilament ply yarn, meshwork of monofils or monofil.

6. The artificial sliding mat according to claim 1, wherein the woven fabric comprises a back coating.

7. The artificial sliding mat according to claim 6, wherein the back coating is formed of at least one of: PVC, styrol butadiene, PUR, latex, PES, PE, PP or hot-melt adhesive.

8. The artificial sliding mat according to claim 1, wherein at least two of the artificial sliding mats are joined together to form a circumferential band.

9. The artificial sliding mat according to claim 1, wherein t least two of the artificial sliding mats are connected via connecting elements.

10. The artificial sliding mat according to claim 9, wherein the connecting elements comprise Velcro fasteners or zippers.

11. The artificial sliding mat according to claim 9, wherein the artificial sliding mat is limited by outer wall elements.

12. The artificial sliding mat according to claim 9, wherein the piste further has cross-pieces.

13. The artificial sliding mat according to any of the claims 11, wherein an outer skin of the outer wall elements and/or the cross pieces is formed of the woven fabric.

14. The artificial sliding mat according to claim 11, wherein the outer wall elements and/or cross-pieces comprise a core of a foamed material.

15. The artificial sliding mat according to claim 11, wherein the outer wall elements are filled with plastic and/or organic material.

16. The artificial sliding mat according to claim 11, wherein an outer skin of the outer wall elements is formed of foil or fleece.

17. The artificial sliding mat according to claim 12, wherein the cross-pieces are attached to the textile piste.
